(19) United States
(12) Patent Application Publication
(10) Pub. No.: US 2021/0272530 A1
(43) Pub. Date: Sep. 2, 2021

(54) CONTROL DEVICE AND LIQUID CRYSTAL DISPLAY DEVICE

(71) Applicant: SAKAI DISPLAY PRODUCTS CORPORATION, Sakai-shi, Osaka (JP)

(72) Inventors: NAOKI HOSOYA, Sakai-shi, Osaka (JP); AKIRA IEYAMA, Sakai-shi, Osaka (JP)

(21) Appl. No.: 17/258,002

(22) PCT Filed: Jul. 13, 2018
(86) PCT No.: PCT/JP2018/026586

§ 371 Date: Jan. 5, 2021

(51) Int. Cl. G09G 3/36

(52) U.S. Cl. CPC G09G 3/3677; G09G 3/3696

(57) ABSTRACT

Each pixel comprises: first and second sub-pixels; a buffer capacitance; first and second switching elements that connect the first and second sub-pixels to a source signal line; and a third switching element that connects the second sub-pixel to the buffer capacitance. The first and second switching elements operate according to a first gate control signal applied from a gate drive circuit. The third switching element operates according to a second gate control signal applied from the gate drive circuit. A power supply circuit generates a first power supply voltage and supplies same to the gate drive circuit during a first time period in which the first and second switching elements are turned ON, and thereafter, generates a second power supply voltage higher than the first power supply voltage, and supplies same to the gate drive circuit during a second time period in which the third switching element is turned ON.

### TECHNICAL FIELD

The invention relates to a control device for a liquid crystal display apparatus and also relates to a liquid crystal display apparatus comprising such a control device.

### BACKGROUND ART

In each of pixels of a liquid crystal display panel, changing the voltage applied to the pixel causes the orientation of liquid crystal molecules of the pixel to change, thereby causing the amount of light passing through the pixel to change to cause the pixel to light with a desired luminance. According to the operating principle, the viewing angle at which video can be viewed with a desired luminance is limited to the vicinity of the front of the liquid crystal display panel. When the liquid crystal display panel is viewed from an oblique direction, the video is seen with luminance being higher than the desired luminance (In other words, the video appears whiter). In particular, the amount of increase in luminance with respect to the desired luminance when the liquid crystal display panel is viewed from the oblique direction is the greatest when a voltage in the vicinity of a voltage corresponding to a halftone luminance is applied to the pixel.

To display video with a desired luminance over a greater viewing angle, a technique in Patent document 1, for example, is being proposed. According to Patent document 1, each of the pixels comprises a first subpixel and a second subpixel. The first subpixel and the second subpixel are connected to a source signal line via a first switching element and a second switching element, respectively. The second subpixel is further connected to a buffer capacitance via a third switching element. The first switching element and the second switching element are turned ON and OFF in accordance with a first gate control signal applied via a first gate signal line from a gate drive circuit. When the first switching element and the second switching element are turned ON, the first subpixel and the second subpixel are charged in accordance with the voltage of a source control signal applied via a source control line from a source drive circuit. The third switching element is turned ON and OFF in accordance with a second gate control signal applied via a second gate signal line from the gate drive circuit. When the third switching element is turned ON, the electric potential of the second subpixel decreases in accordance with the electric potential of the buffer capacitance.

According to Patent document 1, each of the pixels is divided into two subpixels, one subpixel of which is lit with luminance being greater than a desired luminance and the other subpixel of which is lit with luminance being less than the desired luminance, and the desired luminance is realized with the average luminance of these subpixels.

In the specification, realizing a desired luminance with the average luminance of subpixels as in Patent document 1 is below referred to as “a multi-pixel drive scheme”.

### PRIOR ART DOCUMENT

### Patent Document

Patent Document 1: WO 2017/033341 A

### SUMMARY OF THE INVENTION

### Problem to be Solved by the Invention

In a liquid crystal display panel having a multi-pixel drive scheme, each of the pixels is controlled by at least two gate control signals, so that a greater load is applied to a gate drive circuit with respect to a case in which each of the pixels is controlled by one gate control signal. When the magnitude of the load applied to the gate drive circuit fluctuates, the voltage of the gate control signal also fluctuates. In this case, the ON time of switching elements of each of the pixels fluctuates, resulting in fluctuation in luminance of each of subpixels and each of the pixels. By such fluctuation in luminance of each of the pixels, non-uniformity can occur in luminance of the liquid crystal display panel.

An object of the invention is to solve the above-described problems and provide a control device that makes it possible to control a liquid crystal display panel having a multi-pixel drive scheme so as to make an occurrence of non-uniformity in luminance difficult. Moreover, an object of the invention is to provide a liquid crystal display apparatus comprising such liquid crystal display panel and control device.

### Means to Solve the Problem

According to one aspect of the invention,

a control device for a liquid crystal display apparatus comprising a liquid crystal display panel, a gate drive circuit, and a source drive circuit, wherein
the liquid crystal display panel comprises a plurality of pixels arranged along a plurality of scanning lines; a plurality of first gate signal lines and a plurality of second gate signal lines connected to the gate drive circuit; and a plurality of source signal lines connected to the source drive circuit;
each pixel of the plurality of pixels comprises first subpixel and second subpixel; a buffer capacitance; first and second switching elements to connect the first subpixel and the second subpixel, respectively, to one source signal line; and a third switching element to connect the second subpixel to the buffer capacitance, wherein the first and second switching elements operate in accordance with a first gate control signal applied via one first gate signal line from the gate drive circuit and the third switching element operates in accordance with a second gate control signal applied via one second gate signal line from the gate drive circuit; and
the control device comprises a power supply circuit, wherein
   in a first time period in which the first and second switching elements of each pixel, in the plurality of pixels, included in a first scanning line of a frame are transitioned from OFF to ON, the power supply circuit generates a first power supply voltage and supplies the first power supply voltage to the gate drive circuit, and, thereafter,
   in a second time period in which the third switching element of each pixel included in the first scanning line of the frame is transitioned from OFF to ON, the power supply circuit generates a second power supply voltage higher than the first power supply voltage and supplies the second power supply voltage to the gate drive circuit.

### Effects of the Invention

A control device according to one aspect of the invention makes it possible to control a liquid crystal display panel having a multi-pixel drive scheme so as to make an occurrence of non-uniformity in luminance difficult by generating first and second power supply voltages using a power supply circuit as described above.

### BRIEF DESCRIPTION OF THE DRAWINGS

FIG. 1 shows a block diagram of the configuration of a liquid crystal display apparatus according to an embodiment.

FIG. 2 shows a block diagram of the detailed configuration of each of pixels in FIG. 1.

FIG. 3 shows a block diagram of the detailed configuration of a gate drive circuit in FIG. 1.

FIG. 4 shows a block diagram of the detailed configuration of a power supply circuit in FIG. 1.

FIG. 5 shows a graph of a change in power supply voltage supplied to a gate drive circuit of the liquid crystal display apparatus according to a comparative example.

FIG. 6 shows a timing chart of the operation of the liquid crystal display apparatus when a pixel in the vicinity of the upper end of the liquid crystal display panel in FIG. 1 is driven.

FIG. 7 shows a timing chart of the operation of the liquid crystal display apparatus when a pixel in the vicinity of the lower end of the liquid crystal display apparatus in FIG. 1 is driven.

FIG. 8 shows a timing chart to explain that luminance of the pixel changes by changing the delay time of a subgate control signal with respect to a main gate control signal in the liquid crystal display apparatus in FIG. 1.

### EMBODIMENT FOR CARRYING OUT THE INVENTION

With reference to the drawings, a control device and a liquid crystal display apparatus according to each embodiment of the invention will be described. In each Figure, the same reference numerals indicate the same constituting elements.

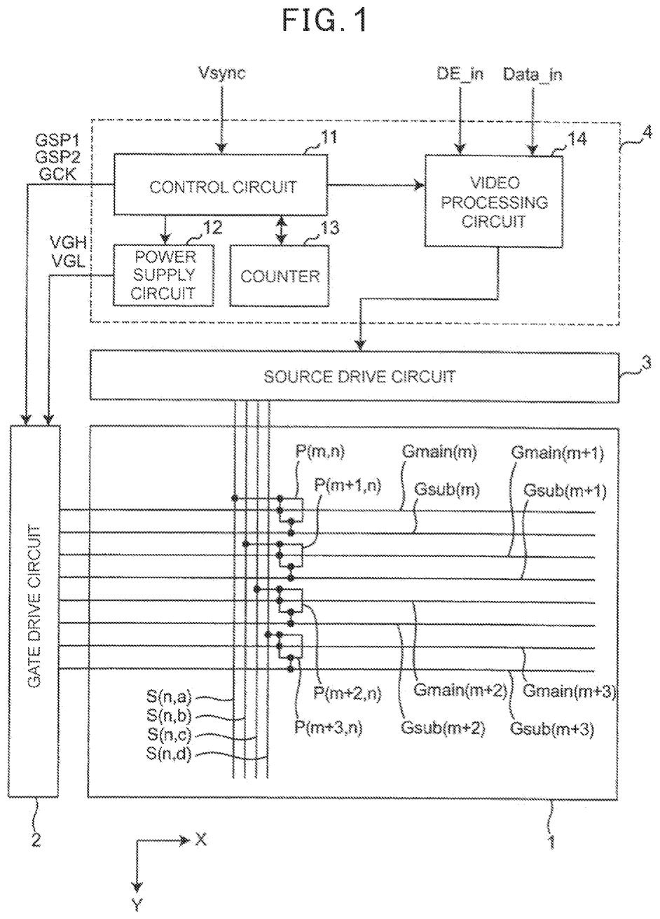

FIG. 1 shows a block diagram of the configuration of a liquid crystal display apparatus 100 according to an embodiment. The liquid crystal display apparatus 100 comprises a liquid crystal display panel 1; a gate drive circuit 2; a source drive circuit 3; and a control device 4.

The liquid crystal display panel 1 comprises a plurality of pixels P(m,n) (1≤m≤M, 1≤n≤N); a plurality of main gate signal lines Gmain(m); a plurality of subgate signal lines Gsub(m); and a plurality of source signal lines S(n,x)(x=a,b,c,d).

The plurality of pixels P(m,n) is arranged along the row direction (X direction in FIG. 1) and the column direction (Y direction in FIG. 1) and, by these pixels P(m,n), a plurality of scanning lines is formed in the row direction of the liquid crystal display panel 1. Each of frames of video to be displayed on the liquid crystal display panel 1 is scanned in order toward the lower end scanning line (also referred to as “the last scanning line”) from the upper end scanning line (also referred to as “the first scanning line”) of the liquid crystal display panel 1. In FIG. 1, for brevity of illustration, only four pixels P(m,n) to P(m+3,n) are shown.

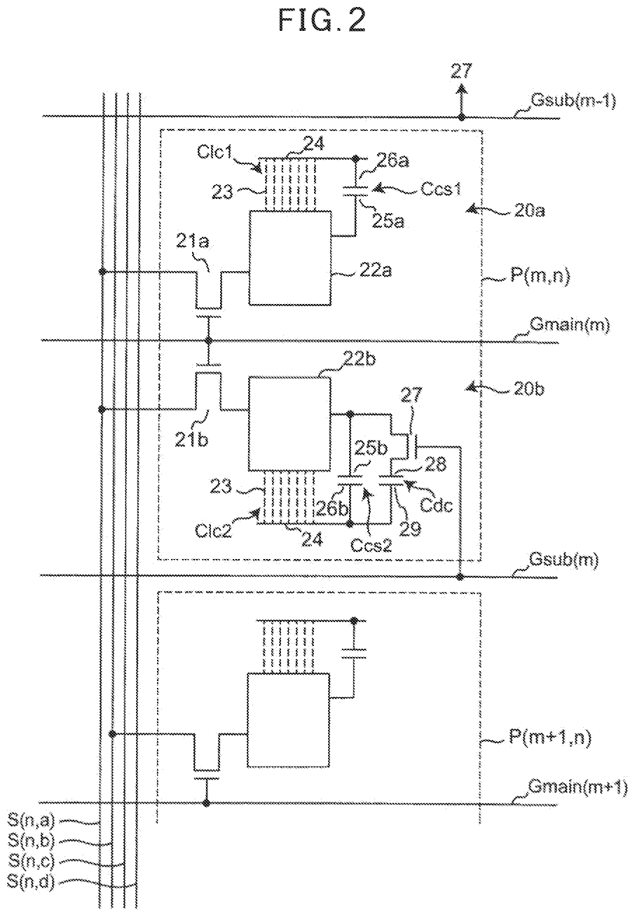

As described below with reference to FIG. 2, each of the pixels P(m,n) is configured to operate using a multi-pixel drive scheme. Therefore, each one of the pixels P(m,n) is connected to the gate drive circuit 2 via one of the main gate signal lines Gmain(m) and one of the subgate signal lines Gsub(m).

In the specification, the main gate signal line Gmain(m) and the subgate signal line Gsub(m) are also referred to as “a first gate signal line” and “a second gate signal line”, respectively.

Moreover, in the example in FIG. 1, the liquid crystal display panel 1 is configured to write video data in a temporally overlapping manner with respect to pixels P(m,n) to P(m+3,n) in four mutually adjacent rows. Therefore, pixels P(m,n) to P(m+3,n) on a certain column are connected to the source drive circuit 3 via four of the source signal lines S(n,a) to S(n,d). Pixels upper to the pixel P(m,n) and pixels lower to the pixel P(m+3,n) in FIG. 1 are also periodically connected to any one of the source signal lines S(n,a) to S(n,d) in the same manner as the pixels P(m,n) to P(m+3,n). Generally, to write video data into each of the pixels on one row, time having the length obtained by dividing time corresponding to one frame by the number of scanning lines can be utilized. However, in this case, as the number of scanning lines or the frame rate increases, the time to write video data into each of the pixels (or, in other words, the charging time of each of the pixels) can be insufficient. On the other hand, as in the example in FIG. 1, by writing the video data in the temporally overlapping manner with respect to pixels P(m,n) to P(m+3,n) of a plurality of rows, the time of a sufficient length to write the video data into each of the pixels can be obtained even when the number of scanning lines or the frame rate increases.

The gate drive circuit 2 supplies a plurality of gate control signals, which selects each of the pixels P(m, n) for each row, to each of the pixels P(m,n) via the plurality of main gate signal lines Gmain(m) and the plurality of subgate signal lines Gsub(m) under the control of the control device 4.

The source drive circuit 3 supplies a plurality of source control signals, which indicates the grayscale of each of the pixels P(m,n) of video along one of the scanning lines, to each of the pixels P(m,n) via the plurality of source signal lines S(n,x) under the control of the control device 4. In detail, the source drive circuit 3 accumulates video data (digital serial data) supplied from the control device 4 by a horizontal scan period H to generate a source control signal (analog parallel data) representing one row of video and apply, in parallel, the generated source control signal to each of the source signal lines S(n,x). Here, the source control signal corresponding to one row is updated for each horizontal scanning period. Moreover, the polarity of the source control signal to be written to each of the pixels P(m,n) is inverted for each frame and for each line.

The control device 4 comprises a control circuit 11; a power supply circuit 12; a counter 13; and a video processing circuit 14.

The control circuit 11 controls the gate drive circuit 2 and the source drive circuit 3 so as to display one frame of video upon receiving a vertical synchronization signal Vsync from a pre-stage circuit (not shown). In particular, the control circuit 11 generates control signals GSP1, GSP2 and a clock signal GCK and supplies those to the gate drive circuit 2. The control signal GSP1 instructs the rise and the fall of the gate control signal of a main gate signal line Gmain(1) connected to a pixel P(1,n) included in the first scanning line of a frame. The control signal GSP2 instructs the rise and the fall of the gate control signal of a subgate signal line Gsub(1) connected to the pixel P(1,n) included in the first scanning line of the frame. A fixed or variable delay time is set from when the gate control signal of the main gate signal line Gmain(1) is caused to transition from being at a low level to being at a high level to when the gate control signal of the subgate signal line Gsub(1) is caused to transition from being at a low level to being at a high level. A moment of the rise and the fall of the gate control signal for the pixel P(m,n) (2≤m≤M) included in the scanning line in a second row and beyond of the frame is determined by the gate drive circuit 2 based on the clock signal GCK so as to have a predetermined delay time with respect to the gate control signal for the pixel P(1,n).

The power supply circuit 12 generates power supply voltages VGH, VGL for the gate drive circuit 2 to generate the gate control signal and supplies the power supply voltages VGH, VGL to the gate drive circuit 2 under the control of the control circuit 11. The power supply voltage VGL is used to generate the gate control signal at the low level. The power supply voltage VGH is higher than the power supply voltage VGL and is used to generate the gate control signal at the high level. The power supply circuit 12 generates the power supply voltage VGH being variable, in accordance with the number of main gate signal lines Gmain(m) and subgate signal lines Gsub(m) that supply the gate control signal at the high level.

The counter 13 generates a count value indicating the elapsed time from when the control circuit 11 receives the vertical synchronization signal Vsync. The count value of the counter 13 is used as an internal clock of the control device 4. The control circuit 11 generates the clock signal GCK for the gate drive circuit 2 based on the count value of the counter 13.

Upon receiving a data signal Data_in indicating video data and an enable signal DE_in indicating the beginning portion of each of the scanning lines in the video data from a pre-stage circuit (not shown), the video processing circuit 14 sends the video data to the source drive circuit 3 and controls the source drive circuit 3.

The control device 4 is also referred to as “a timing controller”.

FIG. 2 shows a block diagram of the detailed configuration of the pixels P(m,n) in FIG. 1. As described previously, each of the pixels P(m,n) is configured to operate using the multi-pixel drive scheme. Therefore, the pixels P(m,n) comprise subpixels 20a, 20b being split equally into two in the vertical direction of the display screen of the liquid crystal display panel 1.

The subpixel 20a comprises a switching element 21a; a subpixel electrode 22a; a liquid crystal layer 23; a counter electrode 24; and auxiliary capacitance electrodes 25a, 26a. The source of the switching element 21a is connected to the source signal line S(n,a), the drain thereof is connected to the subpixel electrode 22a, and the gate thereof is connected to the main gate signal line Gmain(m). In this way, the subpixel electrode 22a is connected to the source signal line S(n,a) via the switching element 21a. The switching element 21a operates in accordance with the gate control signal applied via the main gate signal line Gmain(m) from the gate drive circuit 2. The switching element 21a is a thin-film transistor (TFT), for example. The subpixel electrode 22a and the counter electrode 24 face each other via the liquid crystal layer 23 and form a liquid crystal capacitance Clc1. Moreover, the auxiliary capacitance electrodes 25a, 26a oppose each other and form an auxiliary capacitance Ccs1. The subpixel electrode 22a and the auxiliary capacitance electrode 25a are electrically connected to each other. Moreover, the counter electrode 24 and the auxiliary capacitance electrode 26a are electrically connected to each other.

The subpixel 20b comprises a switching element 21b; a subpixel electrode 22b; the liquid crystal layer 23; the counter electrode 24; auxiliary capacitance electrodes 25b, 26b; a switching element 27; and buffer capacitance electrodes 28, 29. The source of the switching element 21b is connected to the source signal line S(n,a) being the same as for the switching element 21a, the drain thereof is connected to the subpixel electrode 22b, and the gate thereof is connected to the main gate signal line Gmain(m) being the same as for the switching element 21a. In this way, the subpixel electrode 22b is connected to the source signal line S(n,a) via the switching element 21b. The switching element 21b operates in accordance with the gate control signal applied via the main gate signal line Gmain(m) from the gate drive circuit 2. The buffer capacitance electrode 28 is connected to the subpixel electrode 22b via the switching element 27. The gate of the switching element 27 is connected to the subgate signal line Gsub(m). The switching element 27 operates in accordance with the gate control signal applied via the subgate signal line Gsub(m) from the gate drive circuit 2. The switching elements 21b, 27 are thin-film transistors (TFTs), for example. The subpixel electrode 22b and the counter electrode 24 face each other via the liquid crystal layer 23 and form a liquid crystal capacitance Clc2. Moreover, the auxiliary capacitance electrodes 25b, 26b face each other and form an auxiliary capacitance Ccs2. Furthermore, the buffer capacitance electrodes 28, 29 face each other and form a buffer capacitance Cdc. In other words, the liquid crystal capacitance Clc2 and the auxiliary capacitance Ccs2 are connected to the buffer capacitance Cdc via the switching element 27. The subpixel electrode 22b and the auxiliary capacitance electrode 25b are electrically connected to each other. Moreover, the counter electrode 24, the auxiliary capacitance electrode 26b, and the buffer capacitance electrode 29 are electrically connected to one another.

The sizes of the subpixel electrodes 22a, 22b can be equal to each other, or can be different from each other. Moreover, the counter electrode 24 of the subpixel 20a and the counter electrode 24 of the subpixel 20b can be integrated with each other or can be provided separately. Furthermore, each of the pixels P(m,n) can be divided into three or more subpixels.

As shown in FIG. 2, each of the main gate signal lines Gmain(m) can be arranged so as to cross the center of each of the pixels P (m,n). Moreover, as shown in FIG. 2, each of the subgate signal lines Gsub(m) can be arranged between pixels P(m,n) and P(m+1,n) adjacent to each other. In this case, the main gate signal line Gmain(m) and the subgate signal line Gsub(m) in each row are appropriately spaced, so that leakage of signal between the main gate signal line Gmain(m) and the subgate signal line Gsub(m) is suppressed.

In the specification, the subpixel 20a is also referred to as “a first subpixel”, and the subpixel 20b is also referred to as “a second subpixel”. Moreover, in the specification, the switching element 21a is also referred to as “a first switching element”, the switching element 21b is also referred to as “a second switching element”, and the switching element 27 is also referred to as “a third switching element”. Furthermore, in the specification, a gate control signal applied via the main gate signal line Gmain from the gate drive circuit 2 is also referred to as “a first gate control signal” or “a main gate control signal”. Moreover, in the specification, the gate control signal applied via the subgate signal line Gsub from the gate drive circuit 2 is also called “a second gate control signal” or “a subgate control signal”.

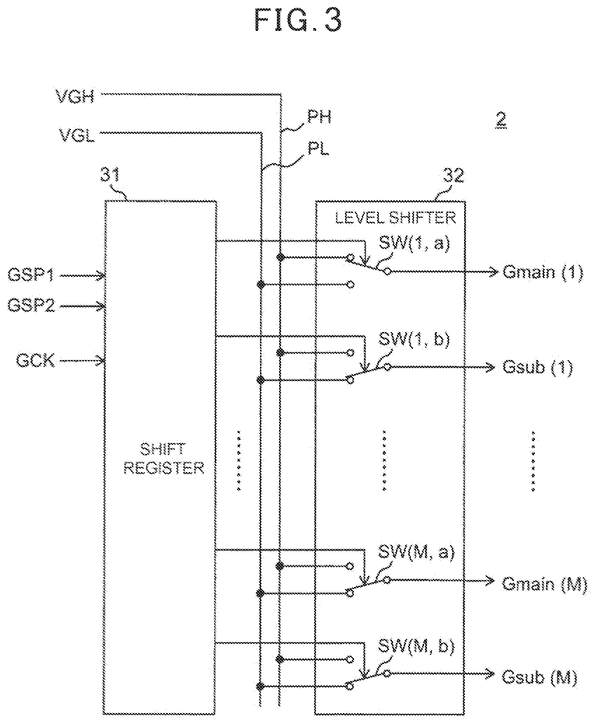

FIG. 3 shows a block diagram of the detailed configuration of the gate drive circuit 2 in FIG. 1. The gate drive circuit 2 comprises a shift register 31; a level shifter 32; and power supply lines PH, PL.

The power supply lines PH, PL are connected to the power supply circuit 12 in FIG. 1. The power supply voltages VGH, VGL generated by the power supply circuit 12 are supplied to the level shifter 32 via the power supply lines PH, PL.

The level shifter 32 generates the main gate control signal and the subgate control signal from the power supply voltages VGH, VGL under the control of the shift register 31. The level shifter 32 comprises switches SW (m,y) (1≤m≤M, y=a,b) to operate under the control of the shift register 31. Each of the switches SW (m,a) comprises two input terminals connected to the power supply lines PH, PL, respectively, and an output terminal connected to the main gate signal line Gmain(m). When each of the switches SW(m,a) connects the power supply line PH to the main gate signal line Gmain(m), a main gate control signal being at the high level is generated; and when connecting the power supply line PL to the main gate signal line Gmain(m), a main gate control signal being at the low level is generated. Moreover, each of the switches SW (m,b) comprises two input terminals connected to the power supply lines PH, PL, respectively, and an output terminal connected to the subgate signal line Gsub(m). When each of the switches SW(m,b) connects the power supply line PH to the subgate signal line Gsub(m), a subgate control signal being at the high level is generated, and when it connecting the power supply line PL to the subgate signal line Gsub(m), a subgate control signal being at the low level is generated.

Based on the control signals GSP1, GSP2 and the clock signal GCK supplied from the control circuit 11 in FIG. 1, the shift register 31 controls each of the switches SW(m,y) so as to adjust the timing of the rise and the fall of the main gate control signal and the subgate control signal.

In the initial state, the shift register 31 controls each of the switches SW(m,y) so as to connect the power supply line PL to the main gate signal Gmain(m) or the subgate signal line Gsub(m).

After the control signal GSP1 transitions from being at the low level to being at the high level, the shift register 31 controls the switch SW (1,a) so as to connect the power supply line PH to the main gate signal line Gmain(1) in conjunction with the first rise of the clock signal GCK. Thereafter, after the control signal GSP1 transitions from being at the high level to being at the low level, the shift register 31 controls the switch SW (1,a) so as to connect the power supply line PL to the main gate signal line Gmain(1) in conjunction with the first rise of the clock signal GCK. With the main gate control signal of the main gate signal line Gmain(1) as a reference, the shift register 31 controls each of the other switches SW (m,a) so that the main gate control signals of the other main gate signal lines Gmain(m) (2≤m≤M) have a delay time corresponding to a predetermined number of clocks and have the same waveform.

Moreover, after the control signal GSP2 transitions from being at the low level to being at the high level, the shift register 31 controls the switch SW (1,b) so as to connect the power supply line PH to the subgate signal line Gsub(1) in conjunction with the first rise of the clock signal GCK. Thereafter, after the control signal GSP2 transitions from being at the high level to being at the low level, the shift register 31 controls the switch SW (1,b) so as to connect the power supply line PL to the subgate signal line Gsub(1) in conjunction with the first rise of the clock signal GCK. With the subgate control signal of the subgate signal line Gsub(1) as a reference, the shift register 31 controls each of the other switches SW (m,b) so that the subgate control signals of the other subgate signal lines Gsub(m) (2≤m≤M) have a delay time corresponding to a predetermined number of clocks and have the same waveform.

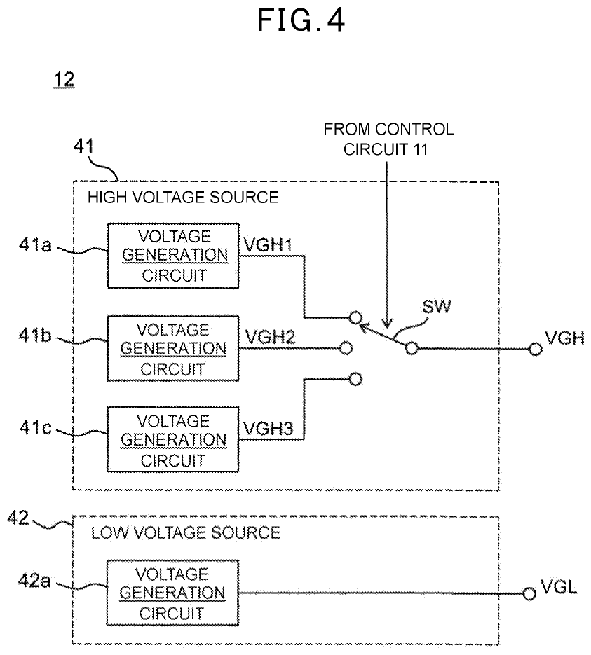

FIG. 4 shows a block diagram of the detailed configuration of the power supply circuit 12 in FIG. 1. The power supply circuit 12 comprises a high voltage source 41 and a low voltage source 42. The high voltage source 41 and the low voltage source 42 are connected to the power supply lines PH,PL, respectively, in FIG. 3.

The high voltage source 41 comprises voltage generation circuits 41a to 41c and a switch SW. The voltage generation circuit 41a generates a power supply voltage VGH1 to be used when the gate drive circuit 2 does not generate the subgate control signal being at the high level, but causes only the main gate control signal to transition from being at the low level to being at the high level. The voltage generation circuit 41b generates a power supply voltage VGH2 to be used when the gate drive circuit 2 generates both the main gate control signal being at the high level and the subgate control signal being at the high level. The power supply voltage VGH2 is higher than the power supply voltage VGH1. The voltage generation circuit 41c generates a power supply voltage VGH3 to be used when the gate drive circuit 2 does not generate the main gate control signal being at the high level, but causes only the subgate control signal to transition from being at the low level to being at the high level. The power supply voltage VGH3 is lower than the power supply voltage VGH1. The power supply voltages VGH1 to VGH3 are set so as to be higher than the gate threshold voltage of the switching elements 21a, 21b, 27 even if taking into account the voltage drop up to reaching the switching elements 21a, 21b, 27 (see FIG. 2) of each of the pixels P (m,n). The switch SW supplies one of the power supply voltages VGH1 to VGH3 to the gate drive circuit 2 as the power supply voltage VGH under the control of the control circuit 11.

In the specification, the power supply voltage VGH1 is also referred to as “a first power supply voltage”, the power supply voltage VGH2 is also referred to as “a second power supply voltage”, and the power supply voltage VGH3 is also referred to as “a third power supply voltage”.

The low voltage source 42 comprises a voltage generation circuit 42a. The voltage generation circuit 42a generates a power supply voltage VGL to be used when each of the pixels P(m,n) of the liquid crystal display panel 1 is not driven (in other words, when each of the switching elements 21, 21b, 27 is turned OFF). The power supply voltage VGL is lower than the gate threshold voltage of the switching elements 21, 21b, 27 (see FIG. 2) of each of the pixels P (m, n).

According to the multi-pixel drive scheme, each of the pixels P(m,n) in FIG. 2 operates as follows.

When the main gate control signal of the main gate signal line Gmain(m) transitions from being at the low level to being at the high level, the switching elements 21a, 21b of the pixels P(m,n) are turned ON. In this way, the voltage of the source control signal of the source signal line S(n,x) is applied to the subpixel electrodes 22a, 22b and the auxiliary capacitance electrodes 25a, 25b of the pixels P(m,n) and, therefore, the voltage applied to the liquid crystal capacitances Clc1, Clc2 and the auxiliary capacitances Ccs1, Ccs2 equals the voltage of the source signal line S(n,x). Thereafter, when the main gate control signal of the main gate signal line Gmain(m) transitions from being at the high level to being at the low level, the switching elements 21a, 21b of the pixels P (m,n) are turned OFF.

After the main gate control signal of the main gate signal line Gmain(m) transitions from being at the high level to being at the low level, and through a predetermined delay time, the subgate control signal of the subgate signal line Gsub(m) transitions from being at the low level to being at the high level; and at this moment, the switching element 27 of the pixels P(m,n) is turned ON. In this way, the buffer capacitance Cdc is connected in parallel to the liquid crystal capacitance Clc2 and the auxiliary capacitance Ccs2.

As described previously, the polarity of the source control signal written into each of the pixels P(m,n) is inverted for each frame and for each line. Before the switching element 27 is turned ON, the buffer capacitance Cdc has the polarity in reverse of that of charges accumulated in the liquid crystal capacitance Clc2 and the auxiliary capacitance Ccs2 since the buffer capacitance Cdc has charges accumulated one frame before. Therefore, when the switching element 27 is turned ON, positive charges (or negative charges) move to the buffer capacitance Cdc from the liquid crystal capacitance Clc2 and the auxiliary capacitance Ccs2, and the absolute value of the voltage applied to the liquid crystal capacitance Clc2 decreases. On the other hand, the voltage applied to the liquid crystal capacitance Clc1 is not influenced by the switching element 27 being turned ON. Therefore, the absolute value of the voltage applied to the liquid crystal capacitance Clc2 is less than the absolute value of the voltage applied to the liquid crystal capacitance Clc1, resulting in a decrease in luminance of the subpixel 20b with respect to luminance of the subpixel 20a. Since a desired luminance is realized by average luminance of the subpixels 20a, 20b, it is possible to realize a halftone luminance without applying, to the subpixels 20a, 20b, a voltage in the vicinity of a voltage corresponding to the halftone luminance. This makes it possible to display video with a desired luminance over a wide viewing angle.

As described previously, with the liquid crystal display panel having the multi-pixel drive scheme according to the conventional art, each of the pixels is controlled by at least two gate control signals, so that a greater load is applied to the gate drive circuit with respect to a case in which each of the pixels is controlled by one gate control signal. When the load applied to the gate drive circuit fluctuates, the voltage of the gate control signal also fluctuates, thereby resulting in the ON time of the switching element of each of the pixels to fluctuate.

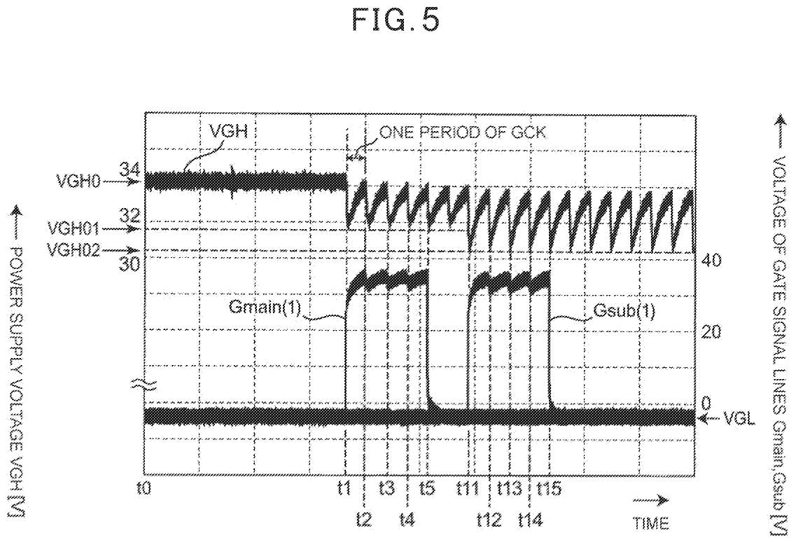

FIG. 5 shows a graph of a change in power supply voltage supplied to a gate drive circuit of a liquid crystal display apparatus according to a comparative example. The example in FIG. 5 shows a case in which fixed power supply voltages VGH, VGL are supplied to the gate drive circuit 2 in the liquid crystal display apparatus comprising the liquid crystal display panel 1 and the gate drive circuit 2, which liquid crystal display apparatus is described with reference to FIGS. 1 to 3. FIG. 5 shows simulation results of the fluctuation of the power supply voltage VGH, the waveform of the main gate control signal of the main gate signal line Gmain(1), and the waveform of the subgate control signal of the subgate signal line Gsub(1).

A fixed power supply voltage VGH=VGH0 is supplied to the gate drive circuit 2. In the time interval t0 to t1, all of the main gate control signals and all of the subgate control signals are at the low level.

When the main gate control signal of the main gate signal line Gmain(1) transitions from being at the low level to being at the high level at the time t1, the power supply voltage VGH decreased to the voltage VGH01 due to increase of the loads that are connected to the main gate signal line Gmain. The main gate control signal of the main gate signal line Gmain(1) was maintained to be at the high level over four periods of the clock signal GCK and transitioned from being at the high level to being at the low level at the time t5. The main gate control signal of the main gate signal line Gmain(2) was generated with a delay time, corresponding to one period of the clock signal GCK, with respect to the main gate control signal of the main gate signal line Gmain(1). Similarly, the main gate control signal of the main gate signal line Gmain(3) and beyond was also generated with a delay time, corresponding to one period of the clock signal GCK, with respect to the main gate control signal of the immediately preceding main gate signal line Gmain(m). As shown in FIG. 5, when the gate drive circuit 2 did not generate a subgate control signal being at the high level, but caused only the main gate control signal to transition from being at the low level to being at the high level (time t1 to t11), the power supply voltage VGH decreased to the voltage VGH01.

At the time t11 at which the subgate control signal of the subgate signal line Gsub(1) transitions from being at the low level to being at the high level while maintaining the main gate control signal of a part of the main gate signal lines Gmain(m) at the high level, the power supply voltage VGH decreased to the voltage VGH02 due to increase of the loads that are connected to the subgate signal line Gsub(1) causes. The subgate control signal of the subgate signal line Gsub(1) was maintained to be at the high level over four periods of the clock signal GCK and transitioned from the high level to the low level at the time t15. The subgate control signal of the subgate signal line Gsub(2) was generated with a delay time, corresponding to one period of the clock signal GCK, with respect to the subgate control signal of the subgate signal line Gsub(1). Similarly, the subgate control signals of the subgate signal line Gsub(3) and beyond are also generated with a delay time, corresponding to one period of the clock signal GCK, with respect to the subgate control signal of the immediately preceding subgate signal line Gsub(m). As shown in FIG. 5, when the gate drive circuit 2 generated both the main gate control signal being at the high level and the subgate control signal being at the high level (at or after the time t11), the power supply voltage VGH decreased to the voltage VGH02.

When the power supply voltage VGH decreases, the voltage of the main gate control signal applied to the gate of the switching elements 21a,21b of each of the pixels P(m,n) decreases, and the ON time of the switching elements 21, 21b decreases. When the ON time of the switching elements 21a, 21b is insufficient, the charging time of the subpixels 20a, 20b by the voltage of the source control signal decreases, and consequently, the luminance of the subpixels 20a, 20b decreases.

Moreover, when the loads that are connected to the main gate signal line Gmain(m) decreases, the power supply voltage VGH increases. When the power supply voltage VGH increases, the voltage of the subgate control signal applied to the gate of the switching element 27 of each of the pixels P(m,n) increases, and the ON time of the switching element 27 increases. When the ON time of the switching element 27 increases, the time in which the switching element 27 is connected to the buffer capacitance Cdc increases, and consequently, the amount of decrease in luminance of the subpixel 20b increases.

Due to the fluctuation in luminance of each of the subpixels 20a, 20b and the fluctuation in luminance of each of the pixels P(m,n) that occur in this way, non-uniformity in luminance of the liquid crystal display panel 1 can occur.

In the liquid crystal apparatus 100 according to the embodiment, the control device 4 controls the liquid crystal display panel 1 having a multi-pixel drive scheme so as to make an occurrence of non-uniformity in luminance difficult. Below, the operation thereof is described.

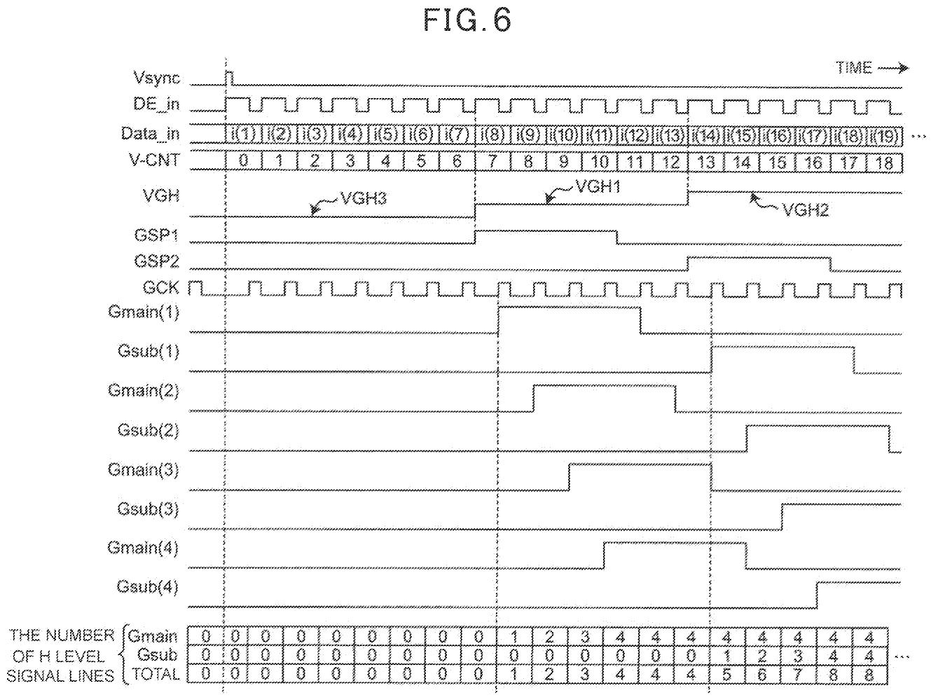

FIG. 6 shows a timing chart of the operation of the liquid crystal display apparatus 100 when the pixel P (m,n) in the vicinity of the upper end of the liquid crystal display panel 1 in FIG. 1 is driven.

The vertical synchronization signal Vsync indicates the beginning portion of each frame. The control circuit 11 causes the counter 13 to start counting of a count value V-CNT in accordance with the rise of the vertical synchronization signal Vsync. In the initial state, the control circuit 11 controls the power supply circuit 12 so as to generate the power supply voltage VGH3 and to supply the power supply voltage VGH3 to the gate drive circuit 2.

When the count value V-CNT=7 is reached, the control circuit 11 causes the control signal GSP1 to transition to being at the high level from being at the low level. At the same time therewith, the control circuit 11 controls the power supply circuit 12 so as to generate the power supply voltage VGH1 being higher than the power supply voltage VGH3 and supply the power supply voltage VGH1 to the gate drive circuit 2. As described previously, the main gate control signal of the main gate signal line Gmain(1) is caused to transition from being at the low level to being at the high level in conjunction with the first rise of the clock signal GCK after the control signal GSP1 transitions from being at the low level to being at the high level. In other words, in the time interval with the count value V-CNT=7, the switching elements 21a, 21b of each of the pixels P(1,n) included in the first scanning line of the frame are caused to transition from OFF to ON, and the load that is applied to the gate drive circuit 2 increases. The control circuit 11 controls the power supply circuit 12 so as to generate the power supply voltage VGH1 and supply the power supply voltage VGH1 to the gate drive circuit 2 in a predetermined time period including the time interval with the count value V-CNT=7, namely, a time period over the count value V-CNT=7 to 12 (also referred to as “a first time period”). In other words, the control circuit 11 controls the power supply circuit 12 so as to generate the power supply voltage VGH1 and supply the power supply voltage VGH1 to the gate drive circuit 2 in the first time period in which the switching elements 21a, 21b of each of the pixels P(1,n) included in the first scanning line of the frame are transitioned from OFF to ON. The control circuit 11 causes the control signal GSP1 to transition from being at the high level to being at the low level when the count value V-CNT=11 is reached.

Thereafter, the control circuit 11 causes the control signal GSP2 to transition from being at the low level to being at the high level when the count value V-CNT=13 is reached. At the same time therewith, the control circuit 11 controls the power supply circuit 12 so as to generate the power supply voltage VGH2 being higher than the power supply voltage VGH1 and supply the power supply voltage VGH2 to the gate drive circuit 2. As described previously, the subgate control signal of the subgate signal line Gsub(1) is caused to transition from being at the low level to being at the high level in conjunction with the first rise of the clock signal GCK after the control signal GSP2 transitions from being at the low level to being at the high level. In other words, in the time interval with the count value V-CNT=13, the switching element 27 of each of the pixels P(1,n) included in the first scanning line of the frame is caused to transition from OFF to ON, and the load that is applied to the gate drive circuit 2 increases. The control circuit 11 controls the power supply circuit 12 so as to generate the power supply voltage VGH2 and supply the power supply voltage VGH2 to the gate drive circuit 2 in a predetermined time period including the time interval with the count value V-CNT=13, namely, a time period over the count value V-CNT=13 and beyond (also referred to as “a second time period”). In other words, the control circuit 11 controls the power supply circuit 12 so as to generate the power supply voltage VGH2 and supply the power supply voltage VGH2 to the gate drive circuit 2 in the second time period in which the switching element 27 of each of the pixels P(1,n) included in the first scanning line of the frame is transitioned from OFF to ON. The second time period continues up to a start of the below-described third time period, or, in other words, up to a time interval with the count value V-CNT=2166. The control circuit 11 causes the control signal GSP2 to transition from being at the high level to being at the low level when the count value V-CNT=17 is reached.

In this way, when the switching element 27 of each of the pixels P(1,n) included in the first scanning line of the frame is turned ON, the power supply voltage VGH supplied to the gate drive circuit 2 is increased, and thereby it is possible to cancel out a decrease in the power supply voltage VGH (see FIG. 5) due to an increase in load. In this way, the ON times of the switching elements 21a, 21b of each of the pixels P(m,n) are made uniform in length, consequently, making it difficult to occur for fluctuation in luminance of each of the subpixels 20a, 20b and each of the pixels P(m,n). Therefore, it is possible to make an occurrence of non-uniformity in luminance of the liquid crystal display panel 1 difficult.

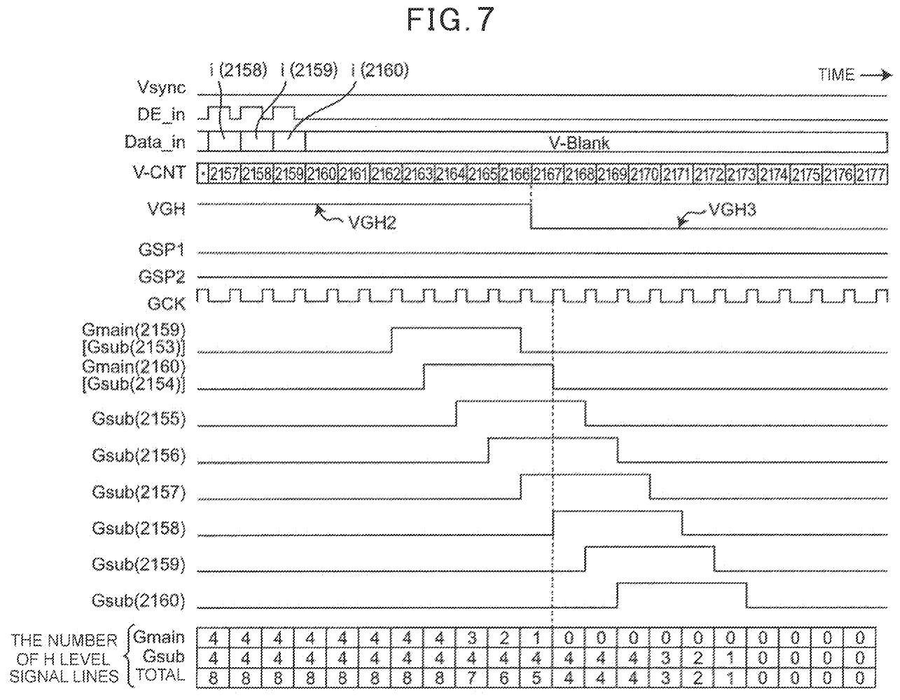

FIG. 7 shows a timing chart of the operation of the liquid crystal display apparatus 100 when the pixel P(m,n) in the vicinity of the lower end of the liquid crystal display apparatus 1 in FIG. 1 is driven.

In a case that the liquid crystal display panel 1 comprises M=2160 scanning lines, for example, when the subgate control signal of the Gsub (2158) that is a 2158-th subgate signal line from the top is transitioned from being at the low level to being at the high level, the main gate control signal of the last main gate signal line Gmain(2160) is transitioned from being at the high level to being at the low level.

The control circuit 11 controls the power supply circuit 12 so as to generate the power supply voltage VGH3 being lower than the power supply voltage VGH1 and supply the power supply voltage VGH3 to the gate drive circuit 2 when the count value V-CNT=2167 is reached, or, in other words, after the count value V-CNT=2160 elapses from the time at which the control signal GSP1 is caused to transition from being at the low level to being at the high level. The main gate control signal of the main gate signal line Gmain(2160) is caused to transition from being at the high level to being at the low level in conjunction with the first rise of the clock signal GCK after the count value V-CNT=2167 is reached. In other words, in the time interval with the count value V-CNT-2167, the switching elements 21a, 21b of each of the pixels P(2160,n) included in the last scanning line of the frame are caused to transition from ON to OFF, and the load that is applied to the gate drive circuit 2 decreases. The control circuit 11 controls the power supply circuit 12 so as to generate the power supply voltage VGH3 and supply the power supply voltage VGH3 to the gate drive circuit 2 in a predetermined time period including the time interval with the count value V-CNT=2167, namely, a time period over the count value V-CNT=2167 and beyond (also referred to as “a third time period”). In other words, the control circuit 11 controls the power supply circuit 12 so as to generate the power supply voltage VGH3 and supply the power supply voltage VGH3 to the gate drive circuit 2 in the third time period in which the switching elements 21a, 21b of each of the pixels P(2160,n) included in the last scanning line of the frame are transitioned from ON to OFF. The third time period continues up to a start of a first time period of the following frame, or, in other words, up to a time interval with the count value V-CNT=6 in the following frame.

In this way, when the switching elements 21a, 21b of each of the pixels P(2160,n) included in the last scanning line of the frame are turned OFF, the power supply voltage VGH supplied to the gate drive circuit 2 is decreased, and thereby it is possible to cancel out an increase in the power supply voltage VGH due to a decrease in load. In this way, the ON times of the switching element 27 of each of the pixels P(m,n) are made uniform in length, consequently, making it difficult to occur for fluctuation in luminance of each of the subpixels 20a, 20b and each of the pixels (m,n). Therefore, it is possible to make an occurrence of non-uniformity in luminance of the liquid crystal display panel 1 difficult.

In a 4K2K liquid crystal display panel comprising 2160 scanning lines, for example, the power supply voltage VGH1 is set to 38.0V, the power supply voltage VGH2 is set to 39.0V, and the power supply voltage VGH3 is set to 36.0V. The power supply voltages VGH1 to VGH3 are construed to be not limited to these values, so that these voltages can be set in accordance with the number of pixels of the liquid crystal display panel, the gate threshold voltage of each of the switching elements 21a, 21b, 27, and the like.

The timing to change the power supply voltage VGH from VGH2 to VGH3 changes in accordance with the number of scanning lines of the liquid crystal display panel 1. In the 4K2K liquid crystal display panel comprising 2160 scanning lines, the power supply voltage VGH, as described previously, is changed when the main gate control signal of the main gate signal line Gmain(2160) is transitioned from being at the high level to being at the low level. In a 2K1K liquid crystal display panel comprising 1080 scanning lines, the power supply voltage VGH is changed when the main gate control signal of the main gate signal line Gmain(1080) is transitioned from being at the high level to being at the low level. In an 8K4K liquid crystal display panel comprising 4320 scanning lines, the power supply voltage VGH is changed when the main gate control signal of the main gate signal line Gmain(4320) is transitioned from being at the high level to being at the low level. In any one of the cases, the power supply voltage VGH is changed before the time period in which the main gate control signals of all of the main gate signal lines Gmain(m) are transitioned from being at the high level to being at the low level and only the subgate control signal of the subgate signal line Gsub(m) is at the high level.

In the liquid crystal display panel having the multi-pixel drive scheme according to the conventional art, luminance of each of the subpixels and each of the pixels could fluctuate due to fluctuation in magnitude of load applied to the gate drive circuit as described previously. Therefore, the delay time of the subgate control signal with respect to the main gate control signal needs to be set as a very small value (a fixed value, for example) so that fluctuation in luminance occurs in the vicinity of the upper end of the liquid crystal display panel (in other words, under the bezel of the liquid crystal display apparatus) and fluctuation in luminance does not appear substantially. On the other hand, in the liquid crystal display apparatus 100 according to the present embodiment, an occurrence of fluctuation in luminance of each of the subpixels 20a, 20b and each of the pixels P(m,n) is made difficult as described above, therefore, it is possible to set the delay time of the subgate control signal with respect to the main gate control signal arbitrarily, not limited to a very small value.

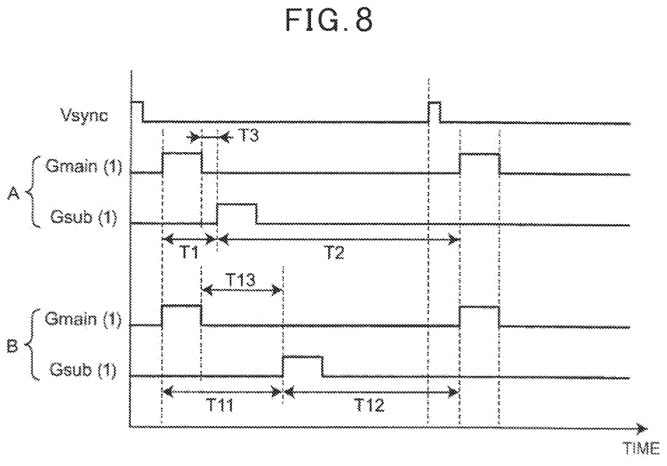

FIG. 8 shows a timing chart to explain that luminance of the pixels P(m,n) changes by changing the delay time of the sub-gate control signal with respect to the main gate control signal in the liquid crystal display apparatus 100 in FIG. 1. In a case A in FIG. 8, the subgate control signal of the subgate signal line Gsub(1) has a delay time T3 with respect to the main gate control signal of the main gate signal line Gmain(1). In this way, in the time period T1, the subpixels 20a, 20b are lit with mutually the same luminance, while, in the time period T2 being after the switching element 27 is turned ON, luminance of the subpixel 20b is lower than luminance of the subpixel 20a. Moreover, in a case B in FIG. 8, the subgate control signal of the subgate signal line Gsub(1) has a delay time T13 being longer with respect to the main gate control signal of the main gate signal line Gmain(1). In this way, in the time period T11, the subpixels 20a, 20b are lit with mutually the same luminance, while, in the time period T12 being after the switching element 27 is turned ON, luminance of the subpixel 20b is lower than luminance of the subpixel 20a. Luminance of the pixels P(m,n) is determined by the ratio of the time period in which the subpixels 20a, 20b are lit with mutually the same luminance and the time period in which luminance of the subpixel 20b is lower than luminance of the subpixel 20a. Increasing the time period in which luminance of the subpixel 20b is lower than luminance of the subpixel 20a (or, in other words, decreasing the delay time of the subgate control signal with respect to that of the main gate control signal) causes luminance of the pixels P(m,n) to decrease. Decreasing the time period in which luminance of the subpixel 20b is lower than luminance of the subpixel 20a (or, in other words, increasing the delay time of the subgate control signal with respect to that of the main gate control signal) causes luminance of the pixels P(m,n) to increase. Therefore, changing the delay time of the subgate control signal with respect to the main gate control signal makes it possible to change luminance of the pixels P(m,n).

The rise and the fall of the control signals GSP1, GSP2 are controlled by the count value of the counter 13, therefore, by changing the count value from the beginning portion of one frame up to the rise of the control signal GSP2, it is possible to change the delay time of the subgate control signal with respect to the main gate control signal.

The control device 4 can control the gate drive circuit 2 so as to have a variable delay time from when the switching elements 21a, 21b of each of the pixels P(m,n) included in the first scanning line of the frame are turned OFF to when the switching element 27 of each of the pixels P(m,n) included in the first scanning line of the frame is turned ON. Moreover, the control device 4 can control the gate drive circuit 2 so as to have an arbitrary fixed delay time from when the switching elements 21a, 21b of each of the pixels P(m,n) included in the first scanning line of the frame are turned OFF to when the switching element 27 of each of the pixels P(m,n) included in the first scanning line of the frame is turned ON.

In this way, in the liquid crystal display apparatus 100 according to the embodiment, changing the delay time of the subgate control signal with respect to the main gate control signal makes it possible to change luminance of the pixels P(m,n).

In the embodiment described above, the liquid crystal display panel 1 is configured such that video data is written into the pixels P(m,n) in four mutually adjacent rows in a temporally overlapping manner. In replacement thereto, video data can be written into the pixels in two, three, or five or more mutually adjacent rows in a temporally overlapping manner, or video data can be written into the pixel in each row in a temporally non-overlapping manner. In this case, pixels in each of the columns are connected to the source drive circuit via source signal lines in the same number as the number of rows in which video data is written in a temporally overlapping manner. Decreasing the number of source signal lines connected to the pixels in each of the columns makes it difficult to block light transmitting each of the pixels by the source signal lines, and thereby, it is possible to improve the transmittance of light in each of the pixels. On the other hand, by increasing the number of source signal lines connected to the pixels in each of the columns, it is possible to obtain a sufficient length of time in which video data is written into each of the pixels as described previously. Moreover, writing video data into pixels in mutually adjacent rows via mutually different source signal lines makes it possible to make an occurrence of ghost due to the voltage to be applied to a pixel in a certain row being applied to a pixel in an adjacent row difficult.

### INDUSTRIAL APPLICABILITY

The present invention makes it possible to provide a liquid crystal display apparatus having a multi-pixel drive scheme in which non-uniformity in luminance is unlikely to occur.

### DESCRIPTION OF REFERENCE NUMERALS

1 . . . LIQUID CRYSTAL DISPLAY PANEL
2 . . . GATE DRIVE CIRCUIT
3 . . . SOURCE DRIVE CIRCUIT
4 . . . CONTROL DEVICE
P . . . PIXEL
11 . . . CONTROL CIRCUIT
12 . . . POWER SUPPLY CIRCUIT
13 . . . COUNTER
14 . . . VIDEO PROCESSING CIRCUIT
20a, 20b . . . SUBPIXEL
21a, 21b . . . SWITCHING ELEMENT
22a, 22b . . . SUBPIXEL ELECTRODE
23 . . . LIQUID CRYSTAL LAYER
24 . . . COUNTER ELECTRODE
25a, 25b, 26a, 26b . . . AUXILIARY CAPACITANCE ELECTRODE
27 . . . SWITCHING ELEMENT
28, 29 . . . BUFFER CAPACITANCE ELECTRODE
31 . . . SHIFT REGISTER
32 . . . LEVEL SHIFTER
SW(1,a)˜SW(M,b) . . . SWITCH
41 . . . HIGH VOLTAGE SOURCE
41a-41c . . . VOLTAGE GENERATION CIRCUIT
42 . . . LOW VOLTAGE SOURCE
42a . . . VOLTAGE GENERATION CIRCUIT
SW . . . SWITCH

1. A control device for a liquid crystal display apparatus comprising a liquid crystal display panel, a gate drive circuit, and a source drive circuit, wherein
the liquid crystal display panel comprises a plurality of pixels arranged along a plurality of scanning lines; a plurality of first gate signal lines and a plurality of second gate signal lines connected to the gate drive circuit; and a plurality of source signal lines connected to the source drive circuit;
each pixel of the plurality of pixels comprises first subpixel and second subpixel; a buffer capacitance; first and second switching elements to connect the first subpixel and the second subpixel, respectively, to one source signal line; and a third switching element to connect the second subpixel to the buffer capacitance, wherein the first and second switching elements operate in accordance with a first gate control signal applied via one first gate signal line from the gate drive circuit and the third switching element operates in accordance with a second gate control signal applied via one second gate signal line from the gate drive circuit; and
the control device comprises a power supply circuit, wherein
in a first time period including a time period to transition the first and second switching elements of each pixel, in the plurality of pixels, included in a first scanning line of a frame from OFF to ON, the power supply circuit generates a first power supply voltage and supplies the first power supply voltage to the gate drive circuit, and, thereafter,
in a second time period including a time period to transition the third switching element of each pixel included in the first scanning line of the frame from OFF to ON, the power supply circuit generates a second power supply voltage higher than the first power supply voltage and supplies the second power supply voltage to the gate drive circuit.

2. The control device according to claim 1, wherein
in a third time period including a time period to transition the first and second switching elements of each pixel included in a last scanning line of the frame from ON to OFF, the power supply circuit generates a third power supply voltage lower than the first power supply voltage and supplies the third power supply voltage to the gate drive circuit.

3. The control device according to claim 1, wherein
the control device controls the gate drive circuit so as to have a fixed delay time from when the first and second switching elements of each pixel included in the first scanning line of the frame are turned OFF to when the third switching element of each pixel included in the first scanning line of the frame is turned ON.

4. The control device according to claim 1, wherein
the control device controls the gate drive circuit so as to have a variable delay time from when the first and second switching elements of each pixel included in the first scanning line of the frame are turned OFF to when the third switching element of each pixel included in the first scanning line of the frame is turned ON.

5. A liquid crystal display apparatus comprising
the control device according to claim 1;
a liquid crystal display panel;
a gate drive circuit; and
a source drive circuit.
